(19) United States
(12) Patent Application Publication
(10) Pub. No.: US 2008/0305650 A1
(43) Pub. Date: Dec. 11, 2008

(54) CONDUCTING TERMINAL MOUNTING STRUCTURE

(75) Inventor: I-Ming Chen, Taipei City (TW)

Correspondence Address: SINGIM INTERNATIONAL CORP., P.O.BOX 108-00403, TAIPEI, 106, TW

(73) Assignee: SINGIM INTERNATIONAL CORP., Hsin Tien (TW)

(21) Appl. No.: 11/758,003

(22) Filed: Jun. 5, 2007

(51) Int. Cl. H01R 12/00

(52) U.S. Cl. 439/62

(57) ABSTRACT

A conducting terminal mounting structure is disclosed to include a housing having an accommodation chamber and an insertion hole, a circuit board, which is mounted in the accommodation chamber inside the housing and has multiple electric contacts and an adapter interface electrically connectable to an external electronic apparatus, and a terminal set, which comprises multiple conducting terminals and an electrically insulative locating block formed integral with the conducting terminals and fastened to the circuit board to hold the conducting terminals in connection with the circuit board electrically.

### BACKGROUND OF THE INVENTION

1. Field of the Invention

The present invention relates to conducting terminal mounting arrangement and more particularly, to such a conducting terminal mounting structure, which enables conducting terminals to be easily and detachably installed in a circuit board without soldering, saving much the installation time and avoiding false soldering and solder overflow.

2. Description of the Related Art

Following fast development of high technology, innovative consumer electronic products are continuously created and digitalized. Modern digital electronic products, such as digital TVs, digital audio systems, MP3 players, digital cameras, electronic dictionaries, digital video cameras, PDAs, and etc. commonly have a memory card connector for receiving a memory card for storing document data and/or audio-visual data. Commercial memory cards are numerous, including MMC (MultiMedia Card), SD (Secure Digital Memory Card), SMC (Smart Media Card), CF (CompactFlash card), MS (MemoryStick), and other series based on these memory cards. Further, a circuit board of the memory card connector has soldered thereto a plurality of conducting terminals for the contact of the inserted memory card so that data signal can be transmitted from the memory card to the electronic apparatus that carries the memory card connector. Therefore, the positioning between the inserted memory card and the conducting terminals at the circuit board is quite important. Nowadays, it is the market trend to create electronic devices having light, thin, short and small characteristics. In consequence, small-sized (mini) memory card connectors are developed. In a small-sized memory card connector, a gap between each two adjacent conducting terminals is narrow. According to conventional techniques, conducting terminals are soldered to the circuit board. Installing conducting terminals in a circuit board by soldering has numerous drawbacks as follows:

1. Either spot soldering or reflow soldering, soldering conducting terminals to a circuit board requires much labor and time. In case spot soldering is adopted, the problem solder overflow may occur. A solder overflow may cause a short circuit among conducting terminals, lowering the yield rate. In case reflow soldering is adopted to attach small-sized conducting terminals to a small-sized circuit board, reflowing the solder in the conveyorized oven may be unable to melt the solder completely, resulting in a false soldering. Further, conducting terminals may be biased or forced out of position due to an accidental impact or vibration during reflow soldering, thereby prolonging the processing time and increasing the defective rate.

2. When soldering conducting terminals to a circuit board, heat energy may be transmitted to the surrounding circuits and electronic components, causing damage to the surrounding circuits and electronic components or lowering their performance.

3. The modern society pays much attention to environmental protection. To dispose of a waste circuit board, the components and conducting terminals must be detached. Removing conducting terminals from a circuit board requires a high-temperature solder removal process. This conducting terminal dismounting procedure wastes much time and labor.

Therefore, it is desirable to provide a conducting terminal mounting structure that eliminates the aforesaid drawbacks.

### SUMMARY OF THE INVENTION

The present invention has been accomplished under the circumstances in view. It is therefore one object of the present invention to provide a conducting terminal mounting structure, which enables conducting terminals to be quickly installed in a circuit board without soldering, avoiding false soldering and other drawbacks resulted from a soldering process. To achieve this and other objects of the present invention, the conducting terminal mounting structure comprises a housing, a circuit board and a terminal set. The housing comprises an accommodation chamber, and an insertion hole in communication with the accommodation chamber. The circuit board is mounted in the accommodation chamber inside the housing, comprising multiple electric contacts and an adapter interface electrically connectable to an external electronic apparatus. The terminal set comprises multiple conducting terminals, and an electrically insulative locating block formed integral with the conducting terminals and fastened to the circuit board to hold the conducting terminals in connection with the circuit board electrically.

### BRIEF DESCRIPTION OF THE DRAWINGS

FIG. 1 is an elevational view of the preferred embodiment of the present invention.

FIG. 2 is an exploded view of the preferred embodiment of the present invention.

FIG. 3 is an elevational view of a part of the preferred embodiment of the present invention, showing the terminal set fastened to the circuit board.

FIG. 4 is a sectional side view of the preferred embodiment of the present invention.

FIG. 5 is a schematic sectional view, showing a status of the preferred embodiment before insertion of a memory card.

FIG. 6 corresponds to FIG. 5, showing a memory card partially inserted into the insertion hole.

FIG. 7 corresponds to FIG. 6, showing the inserted memory card set into position.

### DETAILED DESCRIPTION OF THE PREFERRED EMBODIMENT

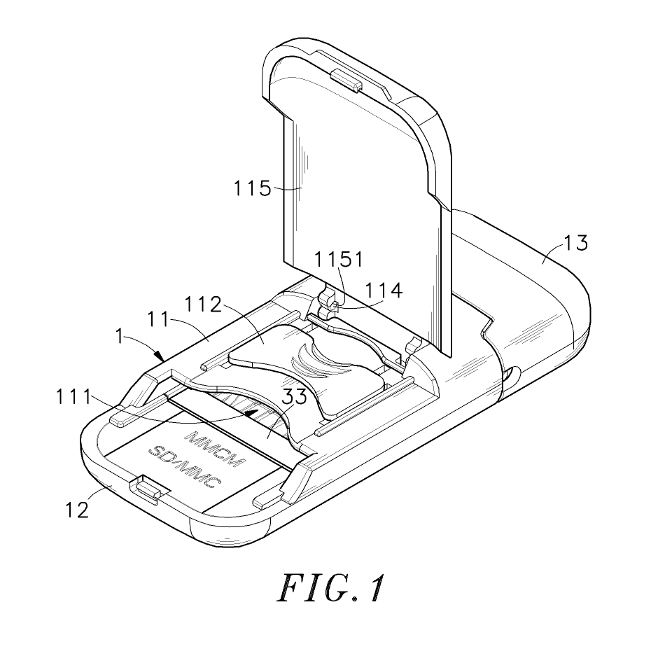

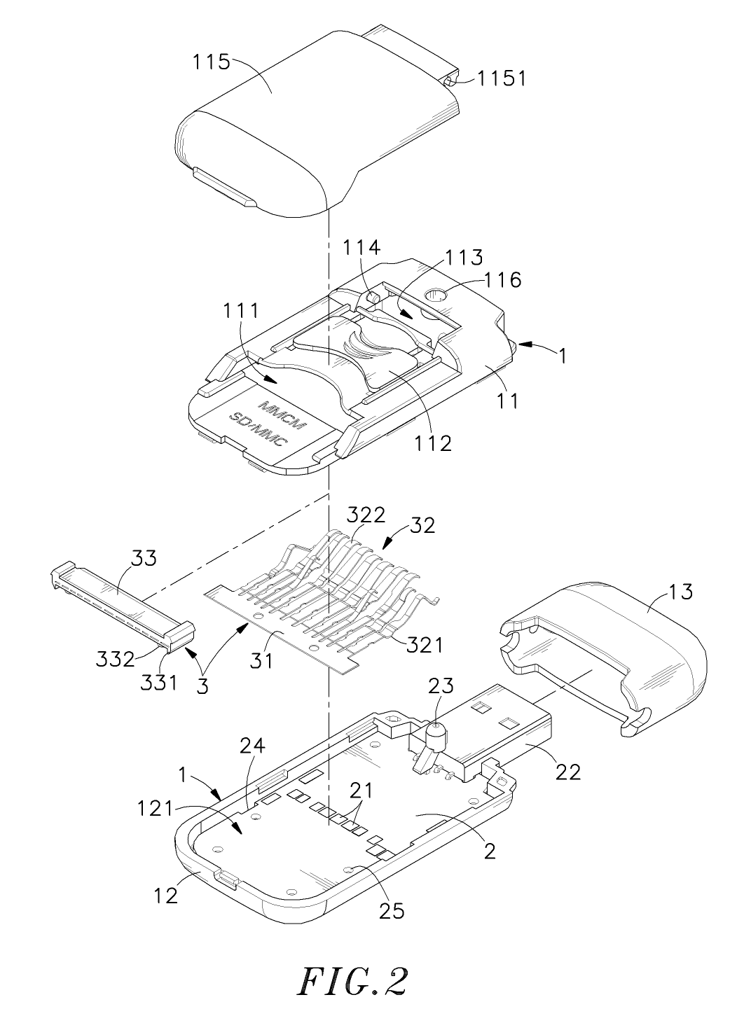

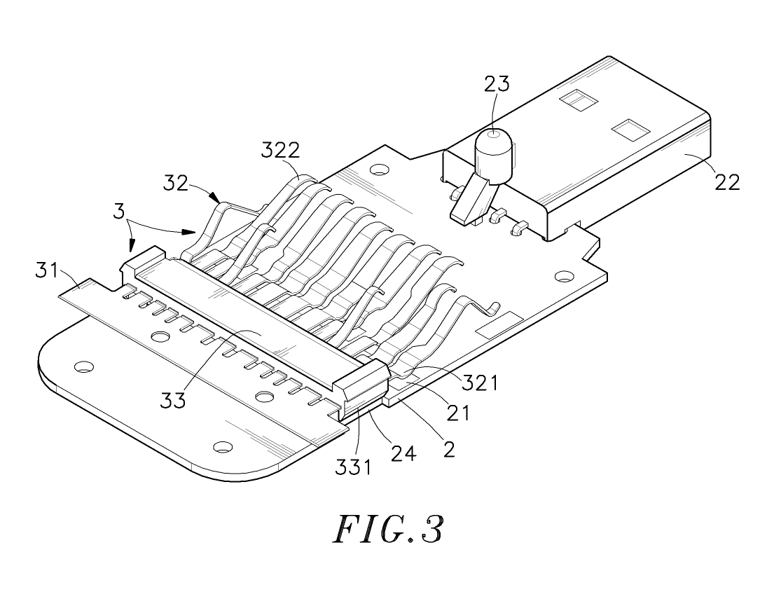

Referring to FIGS. 1-4, a conducting terminal mounting structure in accordance with the present invention is shown comprised of a housing 1, a circuit board 2 and a terminal set 3.

The housing 1 comprises a top shell 11, a bottom shell 12 and an end cap 13. The top shell 11 has an insertion hole 111, a top slide 112, a push block 1121 downwardly extending from the top slide 112 and movable with the top slide 112 toward/away from the insertion hole 111, a vertical through hole 116 near one end remote from the insertion hole 111, a coupling open chamber 113 disposed at the top adjacent to the vertical through hole 116, two pivot rods 114 aligned at two sides of the coupling open chamber 113, and a lifting cover 115, which has two pivot holes 1151 bilaterally disposed at one end and respectively coupled to the pivot rods 114 for enabling the lifting cover 115 to be turned downwards and to outwards to close/open the insertion hole 111. Further, the top shell 11 defines with the bottom shell 12 an accommodation chamber 121.

The circuit board 2 comprises a plurality of electric contacts 21 on the top wall, an adapter interface 22 forwardly extending from the front side, an indicator light 23 for indicating the operation status of the adapter interface 22, two retaining notches 24 symmetrically disposed at two opposite lateral sides, and a plurality of vertical mounting through holes 25.

The terminal set 3 comprises a material bar 31, a plurality of conducting terminals 32 perpendicularly extending from the material bar 31 in a parallel manner, and an electrically insulative locating block 33 formed integral with the conducting terminals 32 adjacent to the material bar 31 by insert molding. The conducting terminals 32 each extend perpendicularly from the material bar 31 in horizontal and terminate in a press portion 321 and then extend obliquely upwards from the press portion 321 and then terminate in a downwardly curved contact portion 322. The locating block 33 comprises two retaining hook portions 331 symmetrically disposed at the two distal ends, and a plurality of bottom mounting rods 332.

During installation, the circuit board 2 is mounted in the accommodation chamber 121 in the bottom shell 12 with the adapter interface 22 suspending outside the bottom shell 12, and then the locating block 33 is fastened to the circuit board 2 by hooking the retaining hook portions 331 on the retaining notches 24 and the bottom mounting rods 332 into the mounting through holes 25 to keep the press portions 321 of the conducting terminals 32 respectively pressed on the electric contacts 21 of the circuit board 2 and the contact portions 322 of the conducting terminals 32 suspending in the insertion hole 111 and the indicator light 23 disposed in the vertical through hole 116.

The adapter interface 22 of the circuit board 2 can be an IEEE 1394 connector or USB connector. Further, the electrically insulative locating block 33 can be formed of two symmetrical parts. During installation, the two symmetrical parts of the electrically insulative locating block 33 are attached to the conducting terminals 32 at the top and bottom sides adjacent to the material bar 31 and then fixedly fastened together. By means of the electrically insulative locating block 33, the conducting terminals 32 can be installed in the circuit board 2 easily and directly without a soldering process, and it is not necessary to break the material bar 31 from the conducting terminals 32 during installation. Because the installation of the conducting terminals 32 in the circuit board 2 does not require a soldering process, the invention saves much conducting terminal installation time, and avoids false soldering and solder overflow. Further, this conducting terminal installation method allows quick dismounting of the conducting terminals.

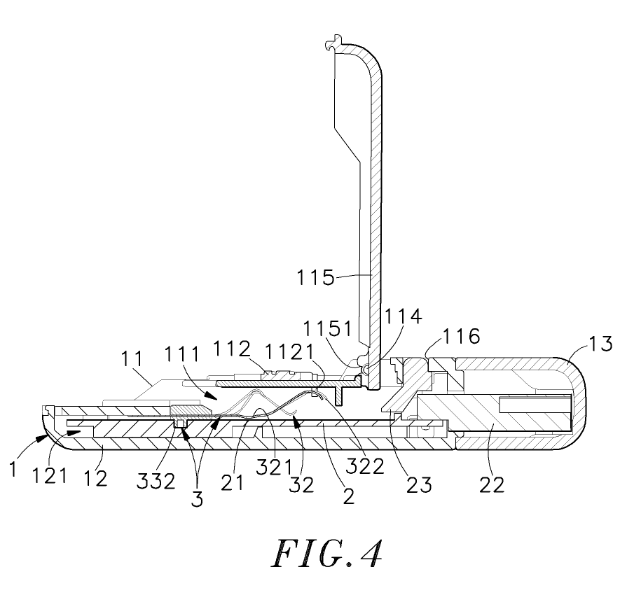

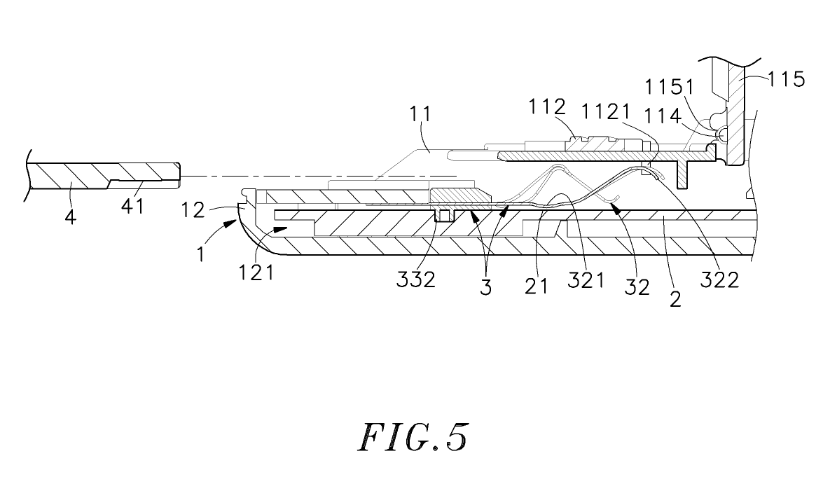

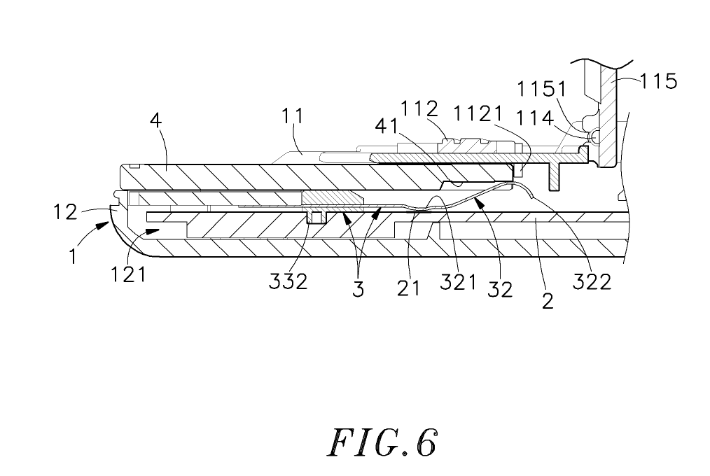

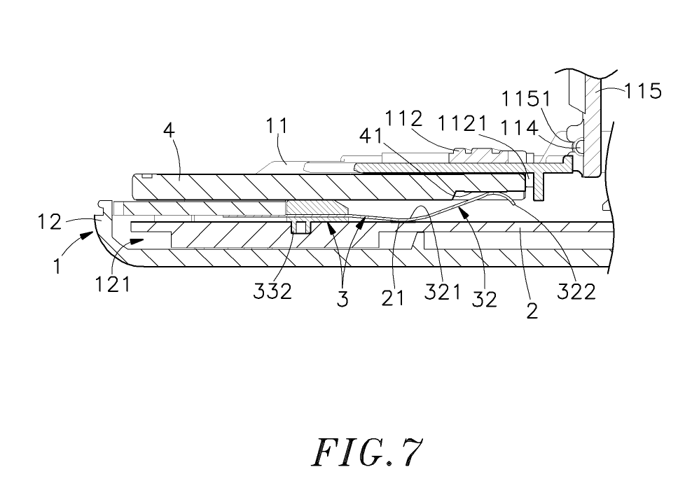

Referring to FIGS. 4-7, when a memory card 4 is inserted into the insertion hole 111 in the top shell 11, the inserted memory card 4 pushes the push block 1121 and the top slide 112 backwards, and the metal contact side 41 of the memory card 4 is electrically pressed on the contact portions 322 of the conducting terminals 32 to impart a downward pressure to the press portion 321 of the conducting terminals 32, thereby forcing the press portions 321 of the conducting terminals 32 into positive contact with the electric contacts 21 of the circuit board 2. After installation, the memory card 4 is electrically connected to the adapter interface 22 of the circuit board 2 through the conducting terminals 32, enabling the electronic apparatus to which the adapter interface 22 is connected to access to the memory card 4. Further, the user can move the top slide 112 outwards, pushing the memory card 4 out of the insertion hole 111.

Further, when wishing to change the status of use of the circuit board 2, the user can disconnect the electrically insulative locating block 33 from the circuit board 2 and then directly bond the conducting terminals 32 to the circuit board 2.

As stated above, the invention provides a conducting terminal mounting structure in which an electrically insulative locating block 33 is directly formed integral with a set of conducting terminals 32 by insert molding and then fastened to a circuit board 2 by forcing retaining hook portions 331 and bottom mounting rods 332 of the electrically insulative locating block 33 into engagement with retaining notches 24 and mounting through holes 25 of the circuit board 2 so that the conducting terminals 32 are held down on the circuit board 2 by the electrically insulative locating block 33 to keep the respective press portions 321 of the conducting terminals 32 in contact with respective electric contacts 21 at the circuit board 2 for transmitting signal.

In general, the invention has the following features and advantages:

1. The conducting terminals 32 and the material bar 31 are directly fastened to the circuit board 2 by the electrically insulative locating block 33. This installation procedure does not use a soldering process (spot soldering or reflow soldering), avoiding false soldering and solder overflow. Further, this installation facilitates quick positioning of the small sized conducting terminals 32 on the circuit board 2, saving much installation time, and ensuring positive contact between the conducting terminals 32 and the respective electric contacts 21 at the circuit board 2 for signal transmission.

2. Because the installation of the conducting terminals 32 eliminates a soldering process, the invention shortens the conducting terminal installation time and avoids thermal damage to components of the circuit board 2. Therefore, the electronic components of the circuit board 2 are kept in an excellent condition for high performance for long.

3. When the mounting positions of the conducting terminals 32 on the circuit board 2 are to be changed for a different application, the terminal set 3 can be separated from the circuit board 2, and then the conducting terminals 32 can be directly bonded to the circuit board 2.

Although a particular embodiment of the invention has been described in detail for purposes of illustration, various modifications and enhancements may be made without departing from the spirit and scope of the invention. Accordingly, the invention is not to be limited except as by the appended claims.

What the invention claimed is:

1. A conducting terminal mounting structure comprising:
a housing, said housing comprising an accommodation chamber and an insertion hole in communication with said accommodation chamber for the insertion an external electronic device into said accommodation chamber;
a circuit board mounted in said accommodation chamber inside said housing, said circuit board comprising a plurality of electric contacts; and
a terminal set, said terminal set comprising a plurality of conducting terminals and an electrically insulative locating block formed integral with said conducting terminals and fastened to said circuit board to hold said conducting terminals in connection with said circuit board electrically, said conducting terminals each comprising a press portion extending from said electrically insulative locating block and respectively pressed on the electric contacts of said circuit board and a contact portion extending from said press portion and suspending in said insertion hole for the contact of an external electronic device that is inserted into said insertion hole.

2. The conducting terminal mounting structure as claimed in claim 1, wherein said housing comprises a bottom shell, a top shell covered on said bottom shell, and an end cap capped on said top shell and said bottom shell.

3. The conducting terminal mounting structure as claimed in claim 2, wherein said insertion hole is formed in said top shell; said top shell comprises a top slide movable to push the inserted external electronic device out of said insertion hole, a coupling open chamber, two pivot rods aligned at two sides of said coupling open chamber, and a lifting cover pivotally coupled to said pivot rods and adapted to close said insertion hole.

4. The conducting terminal mounting structure as claimed in claim 1, wherein said circuit board comprises an adapter interface for communication with the external electronic apparatus, and an indicator light adapted to indicate a signal transmission status of said adapter interface.

5. The conducting terminal mounting structure as claimed in claim 4, wherein said adapter interface is an IEEE 1394 connector.

6. The conducting terminal mounting structure as claimed in claim 4, wherein said adapter interface is a USB connector.

7. The conducting terminal mounting structure as claimed in claim 1, wherein said conducting terminals are insert-molded with said electrically insulative locating block.

8. The conducting terminal mounting structure as claimed in claim 1, wherein said circuit board comprises at least one mounting through hole; said electrically insulative locating block comprises at least one bottom mounting rod fastened to said at least one mounting through hole of said circuit board.

9. The conducting terminal mounting structure as claimed in claim 1, wherein said circuit board comprises a plurality of retaining notches symmetrically disposed at two opposite lateral sides thereof; said electrically insulative locating block comprises a plurality of retaining hook portions respectively fastened to the retaining notches of said circuit board.

10. A conducting terminal mounting structure comprising:
a circuit board, said circuit board comprising a plurality of electric contacts; and
a terminal set, said terminal set comprising a plurality of conducting terminals and an electrically insulative locating block formed integral with said conducting terminals and fastened to said circuit board to hold said conducting terminals in connection with said circuit board electrically, said conducting terminals each comprising a press portion extending from said electrically insulative locating block and respectively pressed on the electric contacts of said circuit board and a contact portion extending from said press portion and suspending above said circuit board for the contact of an external electronic device.

11. The conducting terminal mounting structure as claimed in claim 10, wherein said conducting terminals are insert-molded with said electrically insulative locating block.

12. The conducting terminal mounting structure as claimed in claim 10, wherein said circuit board comprises at least one mounting through hole; said electrically insulative locating block comprises at least one bottom mounting rod fastened to said at least one mounting through hole of said circuit board.
